(19) United States
(12) Patent Application Publication
(10) Pub. No.: US 2007/0153262 A1
(43) Pub. Date: Jul. 5, 2007

(54) INSPECTING APPARATUS AND METHOD

(76) Inventors: Dong-seok BAEK, Suwon-si (KR); Je-wan Suh, Yongin-si (KR); Hee-soo Pyun, Suwon-si (KR); Byeong-hwan Jeon, Yongin-si (KR); Yong-ho Choi, Seoul (KR)

Correspondence Address: STANZIONE & KIM, LLP, 919 18TH STREET, N.W., SUITE 440, WASHINGTON, DC, 20006, US

(21) Appl. No.: 11/609,924

(22) Filed: Dec. 13, 2006

(30) Foreign Application Priority Data
Jan. 4, 2006 (KR) 2006-1103

(51) Int. Cl. G01N 21/88

(52) U.S. Cl. 356/237.2

(57) ABSTRACT

An inspecting apparatus and method of inspecting which provides an enhanced clearness. The inspecting apparatus includes a stage to support an article to be inspected, an optical microscope provided with an object lens to approach and withdraw from the stage to inspect the article, and a viewport lens interposed between the article and the object lens to have a predetermined radius of curvature.

### CROSS-REFERENCE TO RELATED APPLICATIONS

This application claims priority from Korean Patent Application No. 2006-0001103, filed on Jan. 4, 2006, in the Korean Intellectual Property Office, the disclosure of which is incorporated herein in its entirety by reference.

### BACKGROUND OF THE INVENTION

1. Field of the Invention

The present general inventive concept relates to an inspecting apparatus and method, and more particularly, to an inspecting apparatus and method to obtain an image having an enhanced clearness.

2. Description of the Related Art

Generally, when a manufacturing process for a semiconductor, an LCD panel or the like is completed, a defective inspection thereof is performed.

An inspecting apparatus includes an optical microscope to inspect whether a wafer, an LCD panel or the like has a defect. The inspecting apparatus may inspect an article to be inspected in a condition in which the optical microscope is disposed in an atmospheric pressure and the article is disposed in a vacuum. An inspection distance from an object lens of the optical microscope to the article is determined according to the focal distance of the object lens.

A conventional inspecting apparatus is disclosed in Japanese Patent First Publication No. 2002-66300. As illustrated in FIG. 1, the inspecting apparatus includes an optical microscope (not illustrated) provided with an object lens 115 to inspect an article 111, and an optical window 113 interposed between the object lens 115 and the article 111 to be sealed by an O-ring (not illustrated). Accordingly, although the optical microscope is disposed in an atmospheric pressure, the inspecting apparatus can inspect the article 111 disposed in a vacuum by means of the optical window 113.

However, when the conventional inspecting apparatus inspects the article 111 while having an inspection distance from the object lens 115 to the article 111, light is refracted while being transmitted through the optical window 113. Thus, a refracted light path Xa and Xb is different from a normal light path Ya and Yb. The difference of the light path may result from mainly a chromatic aberration according to the wavelength of light and a spherical aberration according to the transmitted position through which the light transmits through the optical window 113. The aberrations deteriorate the clearness of an image obtained by the optical microscope with respect to the article 111. Especially, in the case that the inspecting apparatus uses an optical microscope having a high magnifying power, since the inspection distance is small, the clarity of the obtained image is further deteriorated. Accordingly, it is difficult for the inspecting apparatus to accomplish a correct inspection with respect to the article 111.

### SUMMARY OF THE INVENTION

The present general inventive concept provides an inspecting apparatus and method, and more particularly, an inspecting apparatus and method to obtain an image having an enhanced clearness.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept can be achieved by providing an inspecting apparatus comprising: a stage supporting an article to be inspected; an optical microscope provided with an object lens to approach and withdraw from the stage to inspect the article; and a viewport lens interposed between the article and the object lens having a predetermined radius of curvature.

An inspection distance from the object lens to the article can be determined depending on the object lens, and the viewport lens has a radius of curvature so that a light path calibrated through the viewport lens corresponds to a normal light path at the inspection distance.

The optical microscope can be disposed in an atmospheric pressure, the article is disposed inside a process chamber being in a vacuum to have a chamber casing, and the inspecting apparatus may further comprise a viewport holder accommodating the viewport lens to be coupled to the chamber casing.

The viewport holder can comprise: a contact member contacted with the optical microscope, an upper holder interposed between the contact member and the viewport lens, and a lower holder interposed between the viewport lens and the chamber casing.

The inspecting apparatus may further comprise a sealing member sealing a contact between the upper holder and the viewport lens and a contact between the viewport lens and the lower holder.

The sealing member may comprise an O-ring.

The upper holder and the lower holder may respectively comprise sealing accommodating parts to accommodate the sealing member.

The viewport lens may comprise quarts.

The foregoing and/or other aspects and utilities of the present general inventive concept can also be achieved by providing an inspecting method, comprising: supporting an article to be inspected by a stage; mounting a viewport lens having a predetermined radius of curvature; and inspecting the article through the viewport lens by an optical microscope provided with an object lens to approach and to withdraw from the stage.

The viewport lens mounting stage comprises: setting an inspection distance from the object lens to the article based on the object lens, and forming a radius of curvature of the viewport lens so that an light path calibrated through the viewport lens corresponds to a normal light path at the inspection distance.

The viewport mounting stage may comprise accommodating the viewport lens by a viewport holder coupled to a chamber casing provided to a process chamber inside which the article is disposed in a vacuum.

The inspecting method may further comprise sealing a contact between the viewport holder and the viewport lens.

The foregoing and/or other aspects and utilities of the present general inventive concept can also be achieved by providing an inspecting apparatus comprising: a process chamber to receive an article therein to be inspected, an optical microscope provided outside the process chamber and including an object lens to approach and withdraw from a viewport of the process chamber to inspect the article therein, and a viewport lens disposed between the article and the object lens and having a predetermined radius of curvature.

The process chamber may comprise a chamber casing disposed at an upper portion thereof, and a viewport holder disposed along the viewport to hold the viewport lens within the chamber casing and within the path of the viewport to inspect the article.

The viewport holder comprises a contact member disposed on an upper surface of the chamber casing and in contact with the microscope, an upper holder disposed between the contact member and the viewport lens, and a lower holder disposed to be in contact with the upper holder to contain the viewport lens therebetween.

The viewport holder further comprises a first sealing member disposed between the upper holder and the viewport lens to seal and secure the viewport lens in place with respect to the upper holder, the first sealing member provided in a circular shape to surround the viewport; and a second sealing member disposed between the lower holder and the viewport lens to seal and secure the viewport lens in place with respect to the lower holder, the second sealing member provided in a circular shape to surround the viewport.

The upper and lower holders may each comprise a seal accommodating part to accommodate the respective first and second sealing member therein.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 schematically illustrates a light path through an optical window according to a conventional inspecting apparatus;

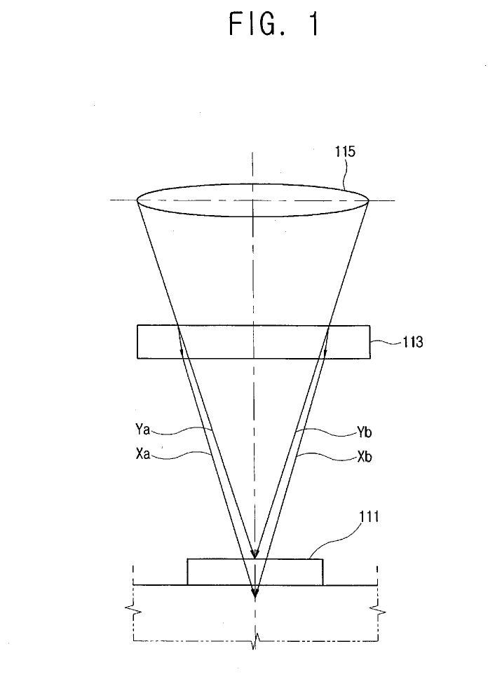

FIG. 2 is a sectional view illustrating an inspecting apparatus according to an embodiment of the present general inventive concept;

FIG. 3 is an expanded perspective view illustrating a main part of the inspecting apparatus in FIG. 2;

FIG. 4 schematically illustrates a light path through a viewport lens in FIG. 2; and

FIG. 5 is a flowchart of an inspecting method usable with the inspecting apparatus in FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

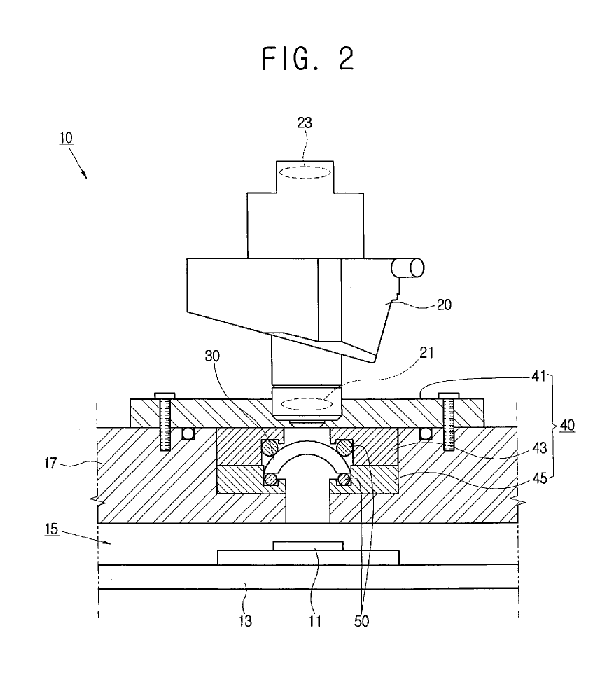

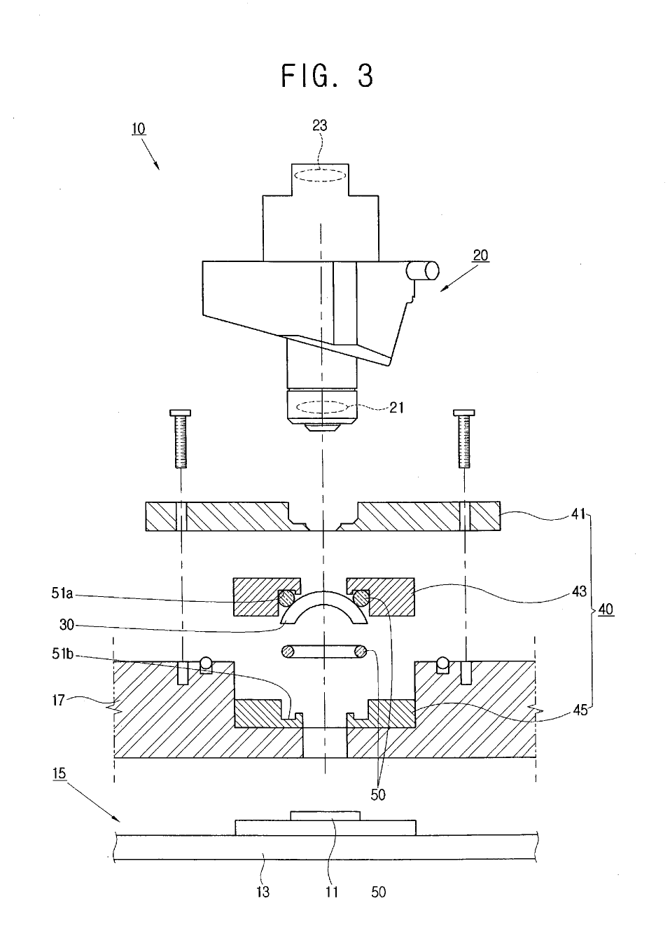

As illustrated in FIGS. 2 and 3, an inspecting apparatus 10 according to an embodiment of the present general inventive concept includes a stage 13 to support an article 11 to be inspected, an optical microscope 20 provided with an object lens 21 to approach and withdraw from the stage 13 to inspect the article 11, and a viewport lens 30 interposed between the article 11 and the object lens 21 with a predetermined radius of curvature. The inspecting apparatus 10 inspects in the condition in which the optical microscope 20 is disposed in an atmospheric pressure and the article 11 is disposed in a vacuum. However, the inspecting apparatus 10 may alternatively inspect the article 11 in other conditions.

The article 11 is transferred through a predetermined process chamber 15, and can be a wafer, an LCD panel, or the like.

The stage 13 supports the article 11 and can include a transferring conveyor, a worktable, or the like, which is capable of supporting and transferring the article 11.

The process chamber 15 is maintained at a predetermined temperature and a predetermined pressure under an atmospheric pressure to perform a process. The process chamber 15 includes a chamber casing 17 that can support the optical microscope 20. A viewport holder 40 is coupled to the chamber casing 17 to accommodate the viewport lens 30.

The optical microscope 20 includes the object lens 21 with a predetermined magnifying power, and an eyepiece 23 with a predetermined magnifying power. The inspecting apparatus 10 may include an image forming part (not illustrated) forming an image based on information which the optical microscope 20 detects.

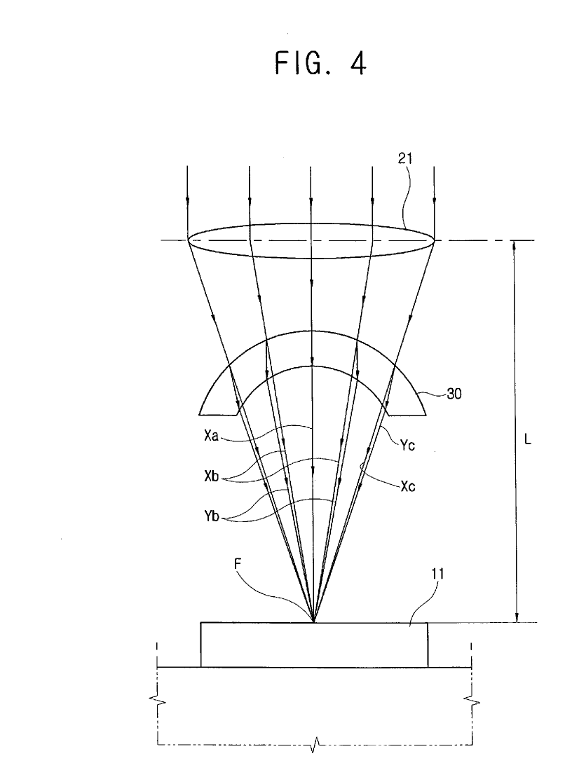

The object lens 21 is disposed to be adjacent to the article 11. Referring to FIG. 4, an inspection distance L from the object lens 21 to the article 11 is determined according to the magnifying power of the object lens 21 having predetermined focal distances.

The viewport lens 30 is interposed between the article 11 and the object lens 21, and has a predetermined radius of curvature so that a calibrated light path refracted through the viewport lens 30 and a normal light path correspond with each other at the inspection distance L. The viewport lens 30 is formed of material having good light transmission, such as quarts or the like, but alternatively the viewport lens 30 may be formed of a plastic material. Accordingly, the optical microscope 20 can obtain a clean image with respect to the article 11 due to a light calibration.

Hereinafter, a calibration of a light path will be described in detail while referring to FIG. 4.

The light path Xa transmits through a center of the object lens 21 and advances straightly to reach a point F regardless of such a medium as the viewport lens 30 interposed between the object lens 21 and the article 11. Since the light path Xa transmits through the center of the viewport lens 30, the light path Xa transmits through the viewport lens 30 without being refracted.

A normal light path Xb transmits through a region in which the medium (such as the viewport lens 30) is not disposed between the object lens 21 and the article 11 to reach the point F. A light path Yb transmits through a region between the object lens 21 and the article 11 in which the viewport lens 30 is disposed, and is refracted through the viewport lens 30 to reach the point F. A light refracts when the light enters the viewport lens 30 at atmospheric pressure, and advances straightly while passing through the viewport lens 30, and refracts while reaching the article 11 in a vacuum. The viewport lens 30 has the radius of curvature so that light is refracted to reach the point F. Accordingly, the normal light path Xb and the refracted light path Yb can reach the same point F.

A normal light path Xc transmits through a circumference of the object lens 21 and straightly advances to reach the point F in the same condition as the normal light path Xb. A refracted light path Yc transmits through the same circumference of the object lens 21 as the normal light path Xc, and is refracted through the viewport lens 30 to reach the point F.

That is, the viewport lens 30 has the radius of curvature so that the refracted light paths Yb and Yc can respectively correspond to the normal light paths Xb and Xc. The radius of curvature of the viewport lens 30 may be determined according to the focal distance of the object lens 21, the refractive index according to material of the viewport lens 30, an environment of the process chamber 15, or the like. Opposite sides of the viewport lens 30 have the curved shapes as illustrated in FIG. 4, but alternatively, a first side of the viewport lens 30 may have a plate shape and a second side thereof may have a curved shape.

Also, the viewport lens 30 has such a predetermined radius of curvature as to be able to withstand a predetermined external force.

The viewport holder 40 accommodates the viewport lens 30 and is coupled to the chamber casing 17 of the process chamber 15 that performs the process in a vacuum. The viewport holder 40 includes a contact member 41 to contact with the optical microscope 20, an upper holder 43 interposed between the contact member 41 and the viewport lens 30, and a lower holder 45 interposed between the viewport lens 30 and the chamber casing 17.

The contact member 41 is provided on a surface of the chamber casing 17 to be coupled thereto by means of a screw or the like. The upper holder 43 includes a sealing accommodating part 51a to accommodate a sealing member 50. The lower holder 45 includes a sealing accommodating part 51b to accommodate a sealing member 50.

The sealing member 50 seals a contact between the upper holder 43 and the viewport lens 30 and a contact between the viewport hens 30 and the lower holder 45. The sealing member 50 may comprise an O-ring. Accordingly, the process chamber 15 can be maintained to be in a vacuum state.

The sealing accommodating parts 51a and 51b are respectively concave on surfaces of the upper holder 43 and the lower holder 45. Accordingly, the sealing accommodating parts 51a and 51b can stably accommodate the sealing member 50.

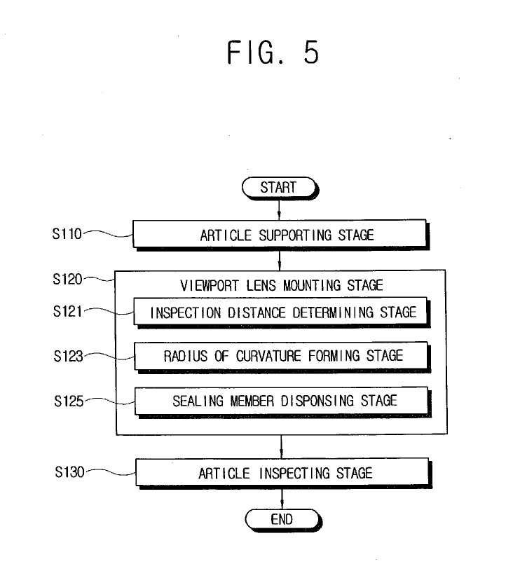

Hereinafter, an inspecting process according to the inspecting apparatus 10 will be described while referring to FIG. 5 and FIG. 2.

As illustrated in FIG. 5, in an article supporting stage performed in operation S110, the stage 13 supports the article 11. The stage 13 may be provided as a conveyor, a worktable or the like.

In a viewport mounting stage performed in operation S120, the viewport lens 30 is mounted between the article 11 and the object lens 21. The viewport mounting stage (operation S120) includes setting an inspection distance from the object lens 21 to the article 11 according to the object lens 21 (operation S121), and forming a radius of curvature of the viewport lens 30 so that a calibrated light path through the viewport lens 30 corresponds to a normal light path at the inspection distance (operation S123).

Thus, a difference of a light path can be calibrated through the viewport lens 30 so that the optical microscope 20 can obtain an image having an enhanced resolution, and accordingly, the inspecting apparatus can obtain an image having an enhanced clearness. Also, since the viewport lens 30 has a predetermined radius of curvature, the viewport lens 30 can enhance the strength thereof.

The viewport mounting stage performed in operation S120 further includes disposing the sealing member 50 between the viewport lens 30 and the viewport holder 40 so that the process chamber 15 is maintained to be in a vacuum (operation S125). Accordingly, the viewport lens 30 can be used in a vacuum.

In an article inspecting stage performed in operation S130, the optical microscope 20 can inspect the article 11 by controlling the object lens 21 to approach or to withdraw from the stage 13. Accordingly, a spherical aberration can be rectified, and the optical microscope 20 can obtain a clean image with respect to the article 11.

The inspecting apparatus according to the present general inventive concept can obtain an image having an enhanced resolution and an enhanced clearness. Accordingly, the inspecting apparatus can obtain correct position information, and thereby can inspect the article efficiently and reliably.

As described above, the inspecting apparatus according to the present general inventive concept can obtain an image having an enhanced clearness, and thereby obtain a correct position information.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inspecting apparatus comprising:
a stage to support an article to be inspected;
an optical microscope provided with an object lens to approach and withdraw from the stage to inspect the article; and
a viewport lens interposed between the article and the object lens and having a predetermined radius of curvature.

2. The inspecting apparatus according to claim 1, wherein:
an inspection distance from the object lens to the article is determined depending on the object lens, and
the viewport lens has a radius of curvature so that a light path calibrated through the viewport lens corresponds to a normal light path at the inspection distance.

3. The inspecting apparatus according to claim 1, wherein
the optical microscope is disposed in an atmospheric pressure,
the article is disposed inside a process chamber being in a vacuum to have a chamber casing, and
the inspecting apparatus further comprises a viewport holder to accommodate the viewport lens to be coupled to the chamber casing.

4. The inspecting apparatus according to claim 3, wherein the viewport holder comprises:
a contact member to contact with the optical microscope,
an upper holder interposed between the contact member and the viewport lens, and
a lower holder interposed between the viewport lens and the chamber casing.

5. The inspecting apparatus according to claim 4, further comprising a sealing member to seal a contact between the upper holder and the viewport lens and a contact between the viewport lens and the lower holder.

6. The inspecting apparatus according to claim 5, wherein the sealing member comprises an O-ring.

7. The inspecting apparatus according to claim 5, wherein the upper holder and the lower holder respectively comprise sealing accommodating parts to accommodate the sealing member.

8. The inspecting apparatus according to claim 2, wherein the optical microscope is disposed in an atmospheric pressure,
the article is disposed inside a process chamber being in a vacuum state and having a chamber casing, and
the inspecting apparatus further comprises a viewport holder to accommodate the viewport lens to be coupled to the chamber casing.

9. The inspecting apparatus according to claim 8, wherein the viewport holder comprises:
a contact member to contact with the optical microscope,
an upper holder interposed between the contact member and the viewport lens, and
a lower holder interposed between the viewport lens and the chamber casing.

10. The inspecting apparatus according to claim 9, further comprising:
a sealing member to seal a contact between the upper holder and the viewport lens and a contact between the viewport lens and the lower holder.

11. The inspecting apparatus according to claim 10, wherein the sealing member comprises an O-ring.

12. The inspecting apparatus according to claim 10, wherein the upper holder and the lower holder respectively comprise sealing accommodating parts to accommodate the sealing member.

13. The inspecting apparatus according to claim 1, wherein the viewport lens comprises quarts.

14. An inspecting method, comprising:
supporting an article to be inspected by a stage;
mounting a viewport lens having a predetermined radius of curvature; and
inspecting the article through the viewport lens by an optical microscope provided with an object lens to approach and to withdraw from the stage.

15. The inspecting method according to claim 14, wherein the viewport lens mounting stage comprises:
setting an inspection distance from the object lens to the article based on the object lens, and
forming a radius of curvature of the viewport lens so that an light path calibrated through the viewport lens corresponds to a normal light path at the inspection distance.

16. The inspecting method according to claim 14, wherein the viewport mounting stage comprises accommodating the viewport lens by a viewport holder coupled to a chamber casing provided to a process chamber inside which the article is disposed in a vacuum.

17. The inspecting method according to claim 16, further comprising:
sealing a contact between the viewport holder and the viewport lens.

18. An inspecting apparatus comprising:
a process chamber to receive an article therein to be inspected;
an optical microscope provided outside the process chamber and including an object lens to approach and withdraw from a viewport of the process chamber to inspect the article therein; and
a viewport lens disposed between the article and the object lens and having a predetermined radius of curvature.

19. The inspection apparatus of claim 18, wherein the process chamber comprises:
a chamber casing disposed at an upper portion thereof; and
a viewport holder disposed along the viewport to hold the viewport lens within the chamber casing and within the path of the viewport to inspect the article.

20. The inspection apparatus according to claim 19, wherein the viewport holder comprises:
a contact member disposed on an upper surface of the chamber casing and in contact with the microscope;
an upper holder disposed between the contact member and the viewport lens; and
a lower holder disposed to be in contact with the upper holder to contain the viewport lens therebetween.

21. The inspection apparatus according to claim 20, wherein the viewport holder further comprises:
a first sealing member disposed between the upper holder and the viewport lens to seal and secure the viewport lens in place with respect to the upper holder, the first sealing member provided in a circular shape to surround the viewport; and
a second sealing member disposed between the lower holder and the viewport lens to seal and secure the viewport lens in place with respect to the lower holder, the second sealing member provided in a circular shape to surround the viewport.

22. The inspection apparatus according to claim 21, wherein the upper and lower holders each comprise a seal accommodating part to accommodate the respective first and second sealing member therein.
